(19) United States
(12) Patent Application Publication
(10) Pub. No.: US 2009/0051516 A1
(43) Pub. Date: Feb. 26, 2009

(54) Assistance System for Assisting a Driver

(75) Inventors: Heinz-Bernhard Abel, Grossostheim-Pflaumheim (DE); Hubert Adamietz, Kleinostheim (DE); Jens Arras, Esselbach Kredenbach (DE); Hans-Peter Kreipe, Dieburg (DE); Bettina Leuchtenberg, Ehringshausen (DE)

Correspondence Address: COHEN, PONTANI, LIEBERMAN & PAVANE LLP, 551 FIFTH AVENUE, SUITE 1210, NEW YORK, NY, 10176, US

(73) Assignee: CONTINENTAL AUTOMOTIVE GmbH

(21) Appl. No.: 12/224,262

(22) PCT Filed: Feb. 16, 2007
(86) PCT No.: PCT/EP2007/051524

§ 371 Date: Aug. 22, 2008

(30) Foreign Application Priority Data
Feb. 23, 2006 (DE) 10 2006 008 981.2

(51) Int. Cl. B60Q 1/00; G08G 1/0968; G08G 1/0967; G08G 1/16; H04N 7/18

(52) U.S. Cl. 340/436; 701/301; 701/117; 348/148; 348/E07.085

(57) ABSTRACT

The invention relates to an assistance system for assisting a driver of a motor vehicle having a plurality of external and internal view sensors (video sources) which supply traffic-related, visual data items, an object detection unit which is connected downstream of the external and internal view sensors, an evaluation logic for evaluating the output variable of the object detection unit and having output channels whose output signals inform the driver by means of a man/machine interface. In order to propose an autonomous system which decides independently, in accordance with the detected objects, whether and how the driver is informed or which engages autonomously in the vehicle movement dynamics in order, for example, to avoid a collision, the invention provides that a decision unit (3) is provided which, when a traffic-related object or a traffic-related situation is detected by the external view sensors (11, 12) and internal view sensors (15, 16), logically combines the visual data items with the output signals, which inform the driver, from the output channels with the effect of controlling or influencing the man/machine interface (4).

The invention relates to an assistance system for assisting a driver of a motor vehicle having a plurality of external and internal sensors (video sources) which supply traffic-related visual data items, an object detection unit which is connected downstream of the external and internal sensors, an evaluation logic for evaluating the output variable of the object detection unit and having output channels whose output signals inform the driver by means of a man/machine interface.

Such assistance systems are among the most recent developments in the automobile industry. Restricted visibility conditions and restricted structural clearances, dazzling effects, persons who are hardly visible or not visible at all, animals and surprising obstacles on the roadway are among the most frequent reasons for accidents. Such systems, which are becoming increasingly important, assist the driver where the limits of human perception are involved and therefore help to reduce the risk of accidents. Two so-called night vision systems of the type mentioned above are described in the specialist article “Integration of night vision and head-up displays” which was published in the Automobiltechnische Zeitung November/2005, Issue 107. However, this publication does not contain any satisfactory concepts which describe which action should be taken, how the action should be taken or how the driver is provided with information when situations which are critical in terms of driving occur in his field of vision. The driver has to do this himself by viewing and interpreting the video image which is provided or the detected (shown) road sign.

The object of the present invention is therefore to propose an autonomous system of the type mentioned at the beginning which, depending on the detected objects, decides independently whether and how the driver is provided with information and/or said system intervenes autonomously in the vehicle movement dynamic in order, for example, to avoid a collision.

This object is achieved according to the invention by virtue of the fact that a decision unit is provided which, when a traffic-related object or a traffic-related situation is detected by the external sensors and internal sensors, logically combines the visual data items with the output signals, which inform the driver, from the output channels with the effect of controlling or influencing the man/machine interface. The object detection means acquires its data from a sensor system for viewing outside the vehicle. Said system may comprise, in particular:
1. Infrared night vision cameras or sensors
2. Daylight cameras
3. Ultrasound systems and radar systems
4. Lidar (Laser-Radar)
5. Other, in particular image-producing sensors.

In order to make the inventive idea concrete, there is provision that when a traffic-related object or a traffic-related situation is detected by means of the external sensors and internal sensors the decision unit generates a visual event, acoustic event or haptic event at the man/machine interface.

One advantageous development of the inventive idea provides that the visual event is formed by means of a video representation in which detected objects are highlighted by coloring whose type is dependent on the hazard potential of the detected objects. The video representation forms a basis for the visual output.

In a further embodiment of the invention, the hazard potential is the product of the absolute distance of the detected object from the vehicle and the distance of the detected object from the predicted driving line.

In this context, it is particularly appropriate if the hazard potential is represented by gradation of the brightness of the coloring or by different colors.

Three advantageous variants are proposed for the visual output:

In the first variant, the video representation is shown continuously on a head-up display. Detected objects are, as has already been mentioned, highlighted by coloring. In addition to the representation of the external view, graphic information, for example road signs, ACC functions, the current vehicle velocity or navigation instructions of a navigation system, is represented on the head-up display.

The second variant consists in the fact that the video representation is shown continuously on a central information display, for example a combination instrument and/or a central console display. In this embodiment variant, detected objects are highlighted by coloring, and in this context a warning message (by means of symbols and text) is output on the central information display in addition to the coloring of the detected objects. In order to attract the driver's attention to the source of the hazard which can be seen on the central information display, a warning message is additionally output on the head-up display.

Finally, the third variant consists in the fact that the video representation is shown temporarily on a central information display. In this context, the activation of the external viewing system is indicated by a control light in the combination instrument of the vehicle. Furthermore, a warning message is output both on the central information display and additionally on the head-up display.

A considerable increase in road safety is achieved in another advantageous refinement of the invention by representing a virtual road profile which corresponds to the real road profile. The virtual road profile is shown graphically and represented in perspective. The road profile information is obtained from the data of the infrared system, a traffic lane detection means which is connected downstream and/or map data from the vehicle navigation system.

One advantageous development of the inventive idea provides that potential obstacles and/or hazardous objects which are located on the roadway are represented. In this context, a data processing system detects, for example, pedestrians, cyclists, animals etc. from the camera data. The size of the represented obstacles and/or hazardous objects varies with their distance from the vehicle. The representation of the obstacles and/or hazardous objects preferably varies as a result of a weighting as a function of the probability of a collision. In this context it is particularly appropriate if relevant and irrelevant obstacles are differentiated. The abovementioned measures improve the quality of the visual representation, in particular on the head-up display. Graphic representation on the head-up display improves the readability by virtue of the contrast ratios with respect to the background of the image. At the same time, the physical loading on the driver is reduced. The hazardous objects can be classified by adjustment of colors. The colors can be assigned as follows:
Green: no hazard
Yellow: increased caution
Red: collision possible

The previously mentioned acoustic events, which are preferably formed by means of sound signals or voice messages, are generated as a function of the urgency of the intended driver reaction (determined by the decision unit). In this context it is particularly advantageous if the preferred amplitude or frequency of the sound signals or of the voice messages can be set in the decision unit by the driver.

The abovementioned haptic event is selected by the decision unit in such a way that it initiates an appropriate reaction by the driver. The haptic event can be a vibration in the driver's seat, a vibration of the steering wheel or a vibration of the accelerator pedal or brake pedal. In this case, it is also particularly advantageous if the preferred amplitude or frequency of the vibration can be set in the decision unit by the driver.

A further refinement of the invention consists in the fact that information about the state of the vehicle, the state of the driver (for example loading, tiredness, . . . ), the behavior of the driver and/or information about preferences of the driver such as display location, functional contents, appearance and the like is fed to the decision unit. Furthermore, information about the vehicle velocity, navigation data (location and time) as well as information about the traffic information (traffic news on the radio) and the like can be fed to the decision unit.

The invention will be explained in more detail in the following description of an exemplary embodiment with reference to the appended drawing. In the drawing:

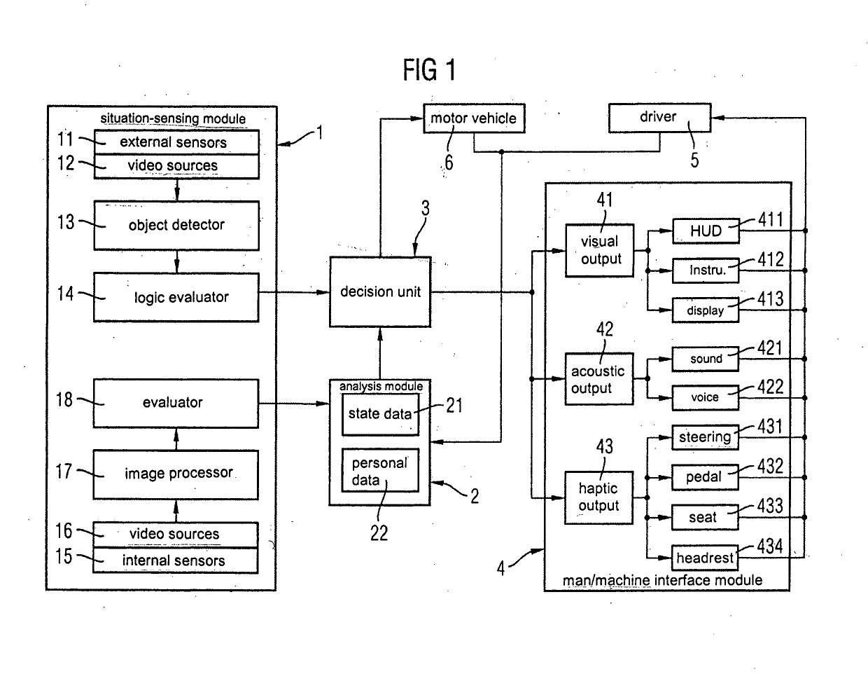

FIG. 1 is a simplified schematic illustration of an embodiment of the assistance system according to the invention, and

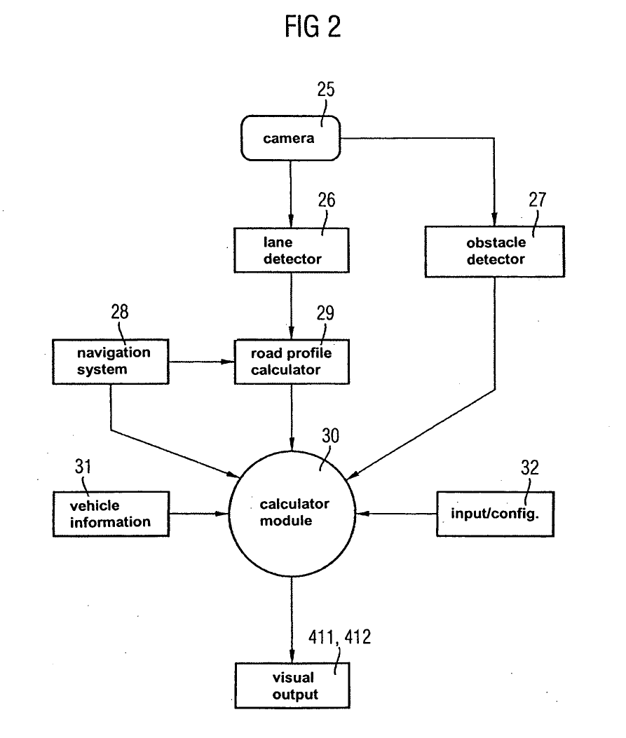

FIG. 2 shows the functional sequence of the processing of a video signal in the assistance system according to the invention.

The assistance system according to the invention which is illustrated in simplified form in FIG. 1 is typically of modular design and is composed essentially of a first or situation-sensing module 1, a second or situation-analysis module 2, a third decision module and/or a decision unit 3, as well as a fourth or man/machine interface module 4. In the illustrated example, the reference symbol 5 denotes the driver, while the reference symbol 6 denotes the motor vehicle which is indicated only schematically. A network or bus system (CAN-Bus) which is not denoted in more detail is provided in the vehicle in order to interconnect the modules. The first module 1 comprises external sensors 11, for example radar sensors, which sense distances from the vehicle travelling in front, and video sources 12, for example a video camera, which is used as a lane detector. The output signals of the abovementioned components are fed to an object detection block 13 in which the objects are detected by means of software algorithms and the output variable of which object detection block 13 is evaluated in an evaluation logic block 14 to determine whether or not a relevant object or a relevant situation is detected. Examples of the relevant objects are pedestrians in the hazardous area, a speed limit or the start of roadworks. The information relating to the objects is made available to the decision unit 3 as a first input variable.

Furthermore, the situation-sensing module 1 comprises internal sensors 15 and video sources 16 whose signals are processed in an image processing block 17 by means of suitable software algorithms to form information which represents, for example, the degree of loading on the driver and which is fed to a second evaluation logic block 18 whose output variable is made available to the second or situation-analysis module 2 as an input variable. An example of a relevant situation is the driver's tiredness. The situation-analysis module 2 contains a criterion data record which includes state data 21 both of the vehicle and of the driver as well as personalization data 22, the preferences of the driver for a display location, functional contents, appearance etc. The output variable of the situation-analysis module 2 is fed to the decision unit 3 as a second input variable, the output channels of which decision unit 3 control or influence in a flexible way the fourth or the man/machine interface module 5. For this purpose, it interacts with visual output destinations (41), acoustic output destinations (42) or haptic output destinations 43 which are denoted by Aₙ in the following description. Examples of the visual output destinations 41 are a head-up display (HUD) 411, a combination instrument 412 or a central console display 413. Permanently assigned display areas on the head-up display (HUD) can be additionally expanded as HUD1, HUD2 as independent output destinations. The decision unit 3 also carries out the prioritization of a driving situation f(x), of the vehicle functions and components with the access to the output destinations. The output destinations can be considered to be a mathematically modelable function of the vehicle functions and components and are represented as a weighting function or decision tensor W(Aₓ) where:
A₁=f(O₁, O₂, . . . Oₙ; F₁, F₂, . . . Fₙ; D₁, D₂, . . . Dₙ)=W(A₁)
A₂=f(O₁, O₂, . . . Oₙ; F₁, F₂, . . . Fₙ; D₁, D₂, . . . Dₙ)=W(A₂)
A₃=f(O₁, O₂, . . . Oₙ; F₁, F₂, . . . Fₙ; D₁, D₂, . . . Dₙ)=W(A₃)
A₄=f(O₁, O₂, . . . Oₙ; F₁, F₂, . . . Fₙ; D₁, D₂, . . . Dₙ)=W(A₄)
A₅=f(O₁, O₂, . . . Oₙ; F₁, F₂, . . . Fₙ; D₁, D₂, . . . Dₙ)=W(A₅)
A₆=f(O₁, O₂, . . . Oₙ; F₁, F₂, . . . Fₙ; D₁, D₂, . . . Dₙ)=W(A₆)
   up to
Aₙ=f(O₁, O₂, . . . Oₙ; F₁, F₂, . . . Fₙ; D₁, D₂, . . . Dₙ)=W (Aₙ)

In this context, objects in the external view, for example a pedestrian, animal, oncoming vehicle, vehicle in the blind spot . . . , are denoted by On, vehicle states, for example navigation, external temperature, traffic information . . . , which are defined by intrinsic data are denoted by Fₙ and states of the driver, for example detection of driver's face, tiredness, pulse, way of gripping the steering wheel (position and force) . . . , are denoted by Dₙ.

In addition there is the personalization Pₙ of vehicle functions and components to the individual output destinations by the driver. The driver does not have any influence on the driver state data through personalization. Each Pₙ therefore constitutes a personalization of an output destination with the functions and components made available by the vehicle, as follows:
P₁=f(O₁, O₂, . . . Oₙ; F₁, F₂, . . . Fₙ)
P₂=f(O₁, O₂, . . . Oₙ; F₁, F₂, . . . Fₙ)
P₃=f(O₁, O₂, . . . Oₙ; F₁, F₂, . . . Fₙ)
P₄=f(O₁, O₂, . . . Oₙ; F₁, F₂, . . . Fₙ)
P₅=f(O₁, O₂, . . . Oₙ; F₁, F₂, . . . Fₙ)
P₆=f(O₁, O₂, . . . Oₙ; F₁, F₂, . . . Fₙ)
   up to
Pₙ=f(O₁, O₂, . . . Oₙ; F₁, F₂, . . . Fₙ)

The driver data, which the decision unit obtains by “measurement”, are used to allow the system to determine a learning curve relating to how well the driver reacts to the selected output destinations in a particular situation f(x). This gives rise to an implied prioritization behavior of the vehicle functions and components in the output destination matrix W(Aₙ). In this context the following applies:

| | |
|---|---|
| O_{D1} = f (D₁, D₂, . . . , Dₙ) | O₁ = W (Fₓ) *O_{D1} |
| O_{D2} = f (D₁, D₂, . . . , Dₙ) | O₂ = W (Fₓ) *O_{D2} |
| up to | |
| O_{Dn} = f (D₁, D₂, . . . , Dₙ) | Oₙ = W (Fₓ) *O_{Dn} |
| and | |
| F_{D1} = f (D₁, D₂, . . . , Dₙ) | F₁ = W (Fₓ) *F_{D1} |
| F_{D2} = f (D₁, D₂, . . . , Dₙ) | F₂ = W (Fₓ) *F_{D2} |
| up to | |
| F_{Dn} = f (D₁, D₂, . . . , Dₙ) | Fₙ = W (Fₓ) *F_{Dn} |

For this purpose, the driver data D₁ to Dₙ are evaluated and weighted by the decision unit 3 by means of their time behavior. The time behavior of the individual functions and components does not have to be additionally taken into account since an independent vehicle function or component can be respectively created for them, for example O₁—pedestrians at a noncritical distance; O₂—pedestrians at a critical distance; O₃—pedestrians in a hazardous area. The driver data which are included in W(Fₓ) take into account a typical driver who is unknown to the system. By storing the data records, the system can record what the reaction behavior of the driver to a specific situation is, by means of the weighting matrices and the associated response function of the driver state (storage of the time profile) and on the basis of the profile of the critical, previously defined functions and components. By means of an assignment to a specific driver N, who has been identified, for example, by a driver's face detection means, a W(F_{N}) where N=1, 2, 3, . . . is stored from W(Fₓ). A decision regarding the future behavior of the decision unit can be made, for example, using fuzzy logic. For this purpose, the recorded data records of each driving situation are evaluated using fuzzy sets of data. Optimization for a faster response time of the driver in conjunction with the development of defined critical parameters of the vehicle functions and data is a strategy for defining a better output behavior. In a first approximation, both the response time and the time behavior of the critical parameters should be weighted equally.

As a variant, a decision unit can be implemented without personalization or without a self-optimizing logic concept.

The previously mentioned acoustic output destinations 42, for example warning sound signals 421 or voice messages 422, are output as a function of the urgency of the intended driver reaction (determined by the decision unit 3). The driver 5 can include the general preferences of the acoustic signals 42 and/or 421/422, for example the amplitude, frequency etc. preferred by the driver, in the criterion data record stored in the situation-analysis module 2.

It is possible, for example, to use vibration messages in the steering wheel 431, in the accelerator pedal or brake pedal 432, in the driver's seat 433, and under certain circumstances in the headrest 434, as haptic output destinations 43. The haptic output destinations 43 are selected by the decision unit 3 in such a way that they initiate an appropriate reaction by the driver. Both the amplitude and the frequency of the haptic feedback can be set by the driver.

As has already been mentioned, a considerable improvement in the visual representation is achieved by virtue of the fact that a virtual road profile, which corresponds to the real road profile and which is represented graphically and in perspective, is represented. As is illustrated in FIG. 2, a video signal from a camera or infrared camera 25 is fed to a downstream lane detection means 26 and to an object, road sign and obstacle detection means 27 for further processing. The road profile is calculated in the function block 29 from the data of the lane detection means 26 and the map data from a vehicle navigation system 28. The calculation of graphic data and the representation of the virtual view are carried out in the function block 30, to which both the map data from the vehicle navigation system 28 and the data from the object, road sign and obstacle detection means 27 as well as further information, for example relating to the vehicle velocity or ACC information (see function block 31) are made available. In this context, the user can use a further function block 32 for user input/configuration to make a selection of all the functions which can be represented, and the user can therefore adapt this display system to his requirements. The virtual road profile information which is formed in this way is finally output on the head-up display 411, the combination instrument 412 and/or the central console display 413.

1.-27. (canceled)

28. An assistance system for assisting a driver of a motor vehicle, comprising:
a plurality of external and internal sensors which supply traffic-related visual data items;
an object detection unit which is operably connected to the system downstream of said plural external and internal sensors;
an evaluation logic unit for evaluating the output variable of the object detection unit;
output channels of the evaluation logig unit whose output signals inform the driver by a man/machine interface; and
a decision unit which logically combines the supplied traffic-related visual data items with the output signals from the output channels when one of a traffic-related object and a traffic-related situation is detected by said plural external sensors and internal sensors, such that the man/machine interface is controlled or influenced to inform the driver of the one of the traffic-related object and the traffic-related situation.

29. The assistance system as claimed in claim 28, wherein the a plurality of external and internal sensors comprise video sources.

30. The assistance system as claimed in claim 28, wherein the decision unit is configured to generate at least one of a visual event, an acoustic event and a haptic event at the man/machine interface when the one of the traffic-related object and traffic-related situation is detected by said plural external sensors and internal sensors.

31. The assistance system as claimed in claim 30, wherein the visual event is formed by a video representation in which detected objects are highlighted by coloring whose type is dependent on a hazard potential of the detected objects.

32. The assistance system as claimed in claim 31, wherein the hazard potential is the product of the absolute distance of the detected object from the vehicle and the distance of the detected object from the predicted driving line.

33. The assistance system as claimed in claim 31, wherein the hazard potential is represented by gradation of the brightness of the coloring or by different colors.

34. The assistance system as claimed in claim 31, wherein the video representation is shown continuously on at least one of a head-up display, a combination instrument and a central console display.

35. The assistance system as claimed in claim 34, wherein graphic information is additionally represented on at least one of the head-up display, the combination instrument and the central console display.

36. The assistance system as claimed in claim 35, wherein the graphic information comprises road signs, adaptive cruise control functions, the current vehicle velocity or navigation instructions of a navigation system.

37. The assistance system as claimed in claim 31, wherein the video representation is shown continuously on a central information display.

38. The assistance system as claimed in claim 37 wherein the video representation includes a warning message output on the central information display.

39. The assistance system as claimed in claim 37, wherein a warning message is additionally output on at least one of a head-up display, a combination instrument and a central console display.

40. The assistance system as claimed in one of claim 31, wherein the video representation is shown temporarily on a central information display.

41. The assistance system as claimed in claim 40, wherein the activation of each of said plural external sensors is indicated by a control light in the combination instrument.

42. The assistance system as claimed in claim 40, wherein the video representation includes a warning message output on the central information display.

43. The assistance system as claimed in claim 40, wherein an additional warning message is output on at least one of a head-up display, a combination instrument and a central console display.

44. The assistance system as claimed in claim 28, further comprising a road profile calculator configured to determine a virtual road profile that is represented on the man/machine interface, said virtual road profile corresponding to a real road profile.

45. The assistance system as claimed in claim 28, wherein at least one of potential obstacles and hazardous objects which are located on the roadway are represented on the man/machine interface.

46. The assistance system as claimed in claim 40, wherein a size of at least one of the represented obstacles and the hazardous objects varies with distance from the vehicle.

47. The assistance system as claimed in claim 40, wherein at least one of the video representation of at least one of the detected obstacles and the hazardous objects varies as a result of a weighting as a function of a probability of a collision.

48. The assistance system as claimed in claim 42, wherein the evaluation logic unit is further configured to differentiate between relevant and irrelevant obstacles.

49. The assistance system as claimed in claim 46, wherein the evaluation logic unit is configured to classify the hazardous objects by adjustment of colors.

50. The assistance system as claimed in claim 30, wherein the acoustic event is formed by one of sound signals and voice messages.

51. The assistance system as claimed in claim 50, wherein one of a preferred amplitude and frequency of the sound signals and the voice messages are settable in the decision unit by the driver.

52. The assistance system as claimed in claim 30, wherein the haptic event is formed by at least one of a vibration in a driver seat, a vibration of the steering wheel of the motor vehicle and a vibration of one of an accelerator pedal and brake pedal of the motor vehicle.

53. The assistance system as claimed in claim 52, wherein the one of the preferred amplitude and frequency of the vibration is settable in the decision unit by the driver.

54. The assistance system as claimed in claim 28, wherein at least one of vehicle state information, behavior information of the driver and information about preferences of the driver is supplied to the decision unit.

55. The assistance system as claimed in claim 28, wherein the information about preferences of the driver comprises at least display location, functional contents and appearance.

56. The assistance system as claimed in claim 28, wherein information about at least one of velocity of the vehicle, navigation data and traffic information are supplied to the decision unit.

57. The assistance system as claimed in claim 55, wherein the navigation data comprises at least one of location and time data.

58. The assistance system as claimed in claim 55, wherein the traffic information comprises radio broadcast traffic news.

59. The assistance system as claimed in claim 28, wherein the assistance system includes an autonomous intrinsic learning capability, such that the interaction of the man/machine interface and an information and warning strategy of the assistance system provided to the driver are optimized and adapted depending on the one of a traffic-related object and a traffic-related situation.
